(19) United States
(12) Patent Application Publication
(10) Pub. No.: US 2025/0103651 A1
(43) Pub. Date: Mar. 27, 2025

(54) SEARCHING FOR INDIRECT ENTITIES USING A KNOWLEDGE GRAPH

(71) Applicant: INTERNATIONAL BUSINESS MACHINES CORPORATION, Armonk, NY (US)

(72) Inventors: Vagner Figueredo de Santana, São Paulo (BR); Stacy F. Hobson, Hopewell Junction, NY (US); Raya Horesh, North Salem, NY (US); Sara E. Berger, Beaverton, OR (US); Aminat Adebiyi, San Jose, CA (US); Alexis Thomas Baria, Whitefish Bay, WI (US); Jessica LaChay Coates, White Plains, NY (US); Lauren Quigley, Red Oak, TX (US); Juana Catalina Becerra Sandoval, Stamford, CT (US)

(21) Appl. No.: 18/471,873

(22) Filed: Sep. 21, 2023

(51) Int. Cl. G06F 16/901; G06F 16/93

(52) U.S. Cl. CPC G06F 16/9024; G06F 16/93

(57) ABSTRACT

Provided are techniques for searching for indirect entities using a knowledge graph. A search request for indirect entities for one or more project specific input documents is received. A knowledge graph is generated with entities and impacts in the one or more project specific input document and with entities and impacts in one or more general input documents. Embedding entities are generated for the entities in the knowledge graph, where each of the embedding entities has a corresponding vectorial representation that represents a position in an embedding space. Embedding entities are identified based on similarity values of the corresponding vectorial representations exceeding a similarity threshold. In response to identifying at least one new entity from the identified embedding entities not explicitly found in the one or more project specific input documents, the at least one new entity is returned as an indirect entity in a search result.

### BACKGROUND

Embodiments of the invention relate to searching for indirect entities using a knowledge graph.

A Recommender System (RS) is designed to predict recommendations to direct actions/products to direct (e.g., immediate) stakeholders (e.g., people/organizations). The RS system is also designed to predict user preferences, matching a specific item/topic to a user profile (or a level of abstraction of the user profile). Also, techniques for designing information systems include stakeholder analysis with a focus on identifying stakeholders directly associated with the product design/development/use or directly impacted.

### SUMMARY

In accordance with certain embodiments, a computer-implemented method comprising operations is provided for searching for indirect entities using a knowledge graph. In such embodiments, a search request for indirect entities for one or more project specific input documents is received. A knowledge graph is generated with entities and impacts in the one or more project specific input document and with entities and impacts in one or more general input documents. Embedding entities are generated for the entities in the knowledge graph, where each of the embedding entities has a corresponding vectorial representation that represents a position in an embedding space. Embedding entities are identified based on similarity values of the corresponding vectorial representations exceeding a similarity threshold. In response to identifying at least one new entity from the identified embedding entities not explicitly found in the one or more project specific input documents, the at least one new entity is returned as an indirect entity in a search result.

In accordance with other embodiments, a computer program product comprising a computer readable storage medium having program code embodied therewith is provided, where the program code is executable by at least one processor to perform operations for searching for indirect entities using a knowledge graph. In such embodiments, a search request for indirect entities for one or more project specific input documents is received. A knowledge graph is generated with entities and impacts in the one or more project specific input document and with entities and impacts in one or more general input documents. Embedding entities are generated for the entities in the knowledge graph, where each of the embedding entities has a corresponding vectorial representation that represents a position in an embedding space. Embedding entities are identified based on similarity values of the corresponding vectorial representations exceeding a similarity threshold. In response to identifying at least one new entity from the identified embedding entities not explicitly found in the one or more project specific input documents, the at least one new entity is returned as an indirect entity in a search result.

In accordance with yet other embodiments, a computer system comprises one or more processors, one or more computer-readable memories and one or more computer-readable, tangible storage devices; and program instructions, stored on at least one of the one or more computer-readable, tangible storage devices for execution by at least one of the one or more processors via at least one of the one or more memories, to perform operations for searching for indirect entities using a knowledge graph. In such embodiments, a search request for indirect entities for one or more project specific input documents is received. A knowledge graph is generated with entities and impacts in the one or more project specific input document and with entities and impacts in one or more general input documents. Embedding entities are generated for the entities in the knowledge graph, where each of the embedding entities has a corresponding vectorial representation that represents a position in an embedding space. Embedding entities are identified based on similarity values of the corresponding vectorial representations exceeding a similarity threshold. In response to identifying at least one new entity from the identified embedding entities not explicitly found in the one or more project specific input documents, the at least one new entity is returned as an indirect entity in a search result.

### BRIEF DESCRIPTION OF THE SEVERAL VIEWS OF THE DRAWINGS

Referring now to the drawings in which like reference numbers represent corresponding parts throughout:

FIG. 1 illustrates a computing environment in accordance with certain embodiments.

FIG. 2 illustrates, in a block diagram, a computing environment for a search system in accordance with certain embodiments.

FIG. 3 illustrates, in a flowchart, operations for generating a knowledge graph with general input documents in accordance with certain embodiments.

FIGS. 4A, 4B, and 4C illustrate, in a flowchart, operations for performing a search using the knowledge graph in accordance with certain embodiments.

FIG. 5 illustrates an example of generation of indirect entities in accordance with certain embodiments.

FIG. 6 illustrates, in a flowchart, operations for identifying indirect entities using a knowledge graph in accordance with certain embodiments.

### DETAILED DESCRIPTION

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 of contains an example of an environment for the execution of at least some of the computer code involved in performing the inventive methods, such as search system 210 of block 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

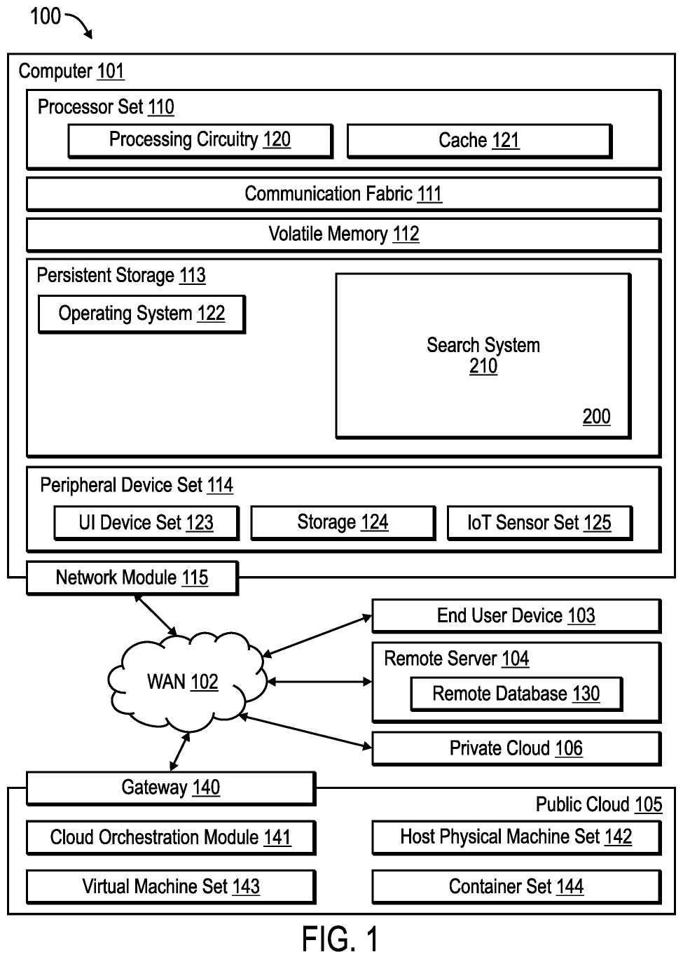

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 012 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

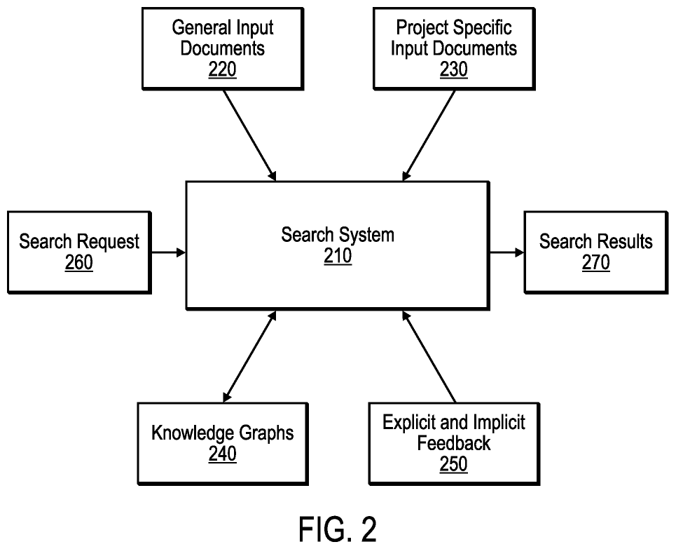

FIG. 2 illustrates, in a block diagram, a computing environment for a search system 210 in accordance with certain embodiments. In FIG. 2, the search system 210 receives general input documents 220 and generates knowledge graphs 240. In response to a search request 260, the search system 210 identifies a particular knowledge graph from the knowledge graphs 240 and updates that particular knowledge graph using project specific input documents 230. Then, the search system 110 uses the updated knowledge graph to generate the search results 270. In addition, the search system 110 receives explicit and implicit feedback and further updates that particular knowledge graph.

In certain embodiments, the search system 210 identifies indirect entities (e.g., stakeholders) and direct entities (e.g., stakeholders) who may be impacted by a project and who are not described in a project specific input document 230 in natural language (e.g., a project document, a project requirements document, etc.) as a way to foresee unintended negative impacts/harms of that project (e.g., of a given information system or technology). The indirect entities may be people, parties, constituents, organizations, communities, companies, environmental groups, biomes, environments, etc.

In certain embodiments, the search system 210 uses natural language processing and social networks to identify entities (e.g., parties, constituents, organizations, communities, biomes, environments, etc.) impacted indirectly and/or directly by a certain technology. In certain embodiments, the search system 210 identifies entities (e.g., stakeholders) that should be considered in a project aiming at responsible computing and responsible outcomes.

In certain embodiments, the search system 210 identifies entities of interest or similar entities in a graph structure (e.g., a knowledge graph 240). With embodiments, the search system 210 identifies indirectly and directly impacted entities by combining natural language processing and ways these entities may be impacted in terms of embeddings. This means that indirect entities may not be directly connected in the knowledge graph, but may be next in the knowledge graph or within a certain distance of a node in the knowledge graph. Then, the search system 210 informs the entities that are indirectly impacted by a certain technology to provide responsible computing.

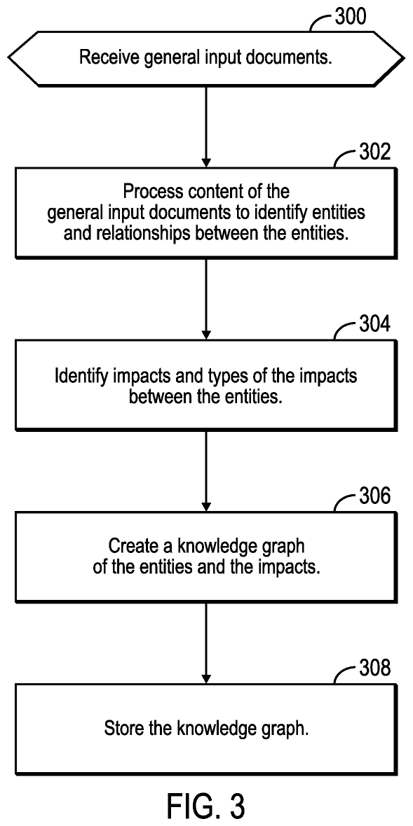

FIG. 3 illustrates, in a flowchart, operations for generating a knowledge graph 240 with general input documents in accordance with certain embodiments. Control begins at block 300 with the search system 210 receiving general input documents 220. For example, the general input documents 220 may include literature, news, social media posts, social network data, project information, computer code, etc.

In block 302, the search system 210 processes the content of the general input documents 220 to identify entities and relationships between the entities. In certain embodiments, the search system 210 processes the textual context of the general input documents 220 (e.g., using natural language processing) and identifies main entities and the relationships between them. With embodiments, different techniques may be used to process the textual content. For example, the search system 210 may use techniques to identify the subjects of sentences and elect those as the entities and identify the verbs of those sentences as relationships linking the entities.

In block 304, the search system 210 identifies impacts and types of the impacts between the entities. In certain embodiments, the search system 210 identifies verbs to determine the impacts (e.g., financial, environmental, legal, etc.).

Thus, in certain embodiments, the search system 210 identifies subjects of sentences as entities, identifies verbs as relationships linking the entities, and uses the verbs to determine the impacts, where the subjects and verbs are from the general input documents.

In block 306, the search system 210 creates a knowledge graph 240 of the entities (nodes) and the impacts (edges), which may be used to inform how the entities may be impacted. In block 308, the search system 210 stores the knowledge graph 240.

In certain embodiments, the search system 210 generates and stores a single, large knowledge graph. In such embodiments, the search system 210 may select a portion (i.e., a subgraph) of the single, large knowledge graph.

In certain other embodiments, embodiments, the search system 210 generates and stores multiple knowledge graphs 240, where each of the knowledge graphs 240 is associated with different entities or different combinations of entities. In such other embodiments, the search system 210 may select a particular knowledge graph 240 from the multiple knowledge graphs 240 based on, for example, entities in a project specific input document 230 matching entities in the knowledge graph 240. The matching may be exact matching or “fuzzy” matching based on various factors.

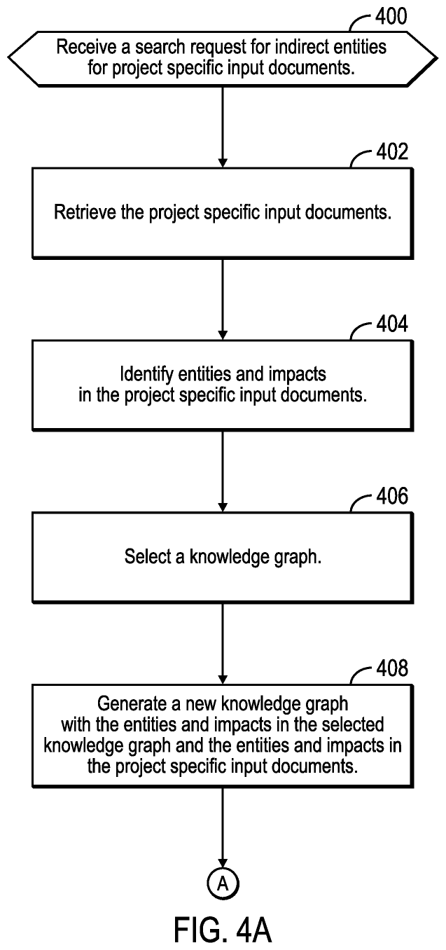

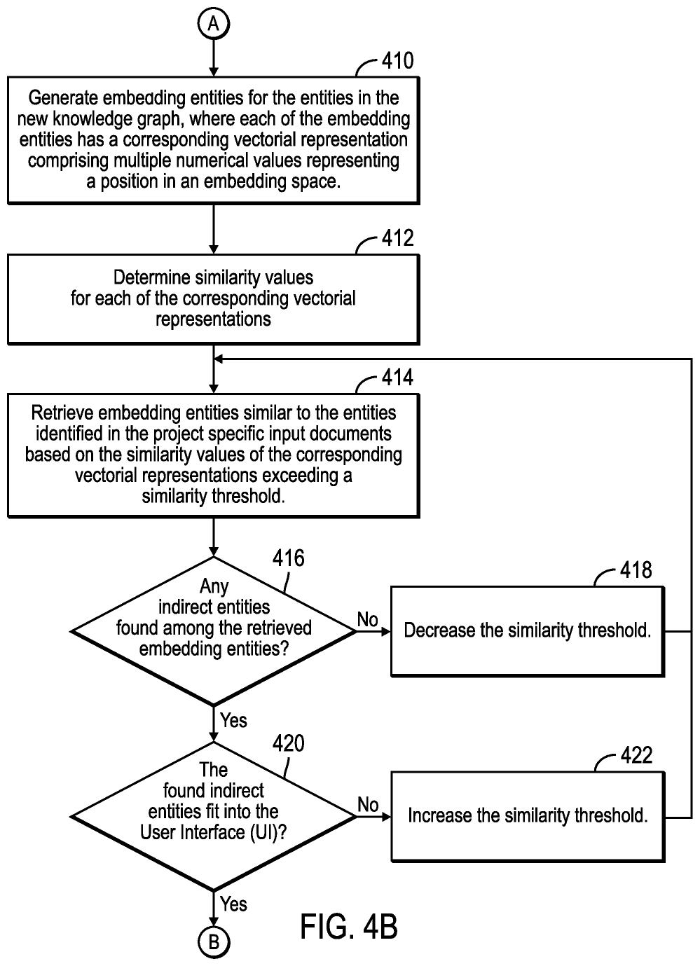

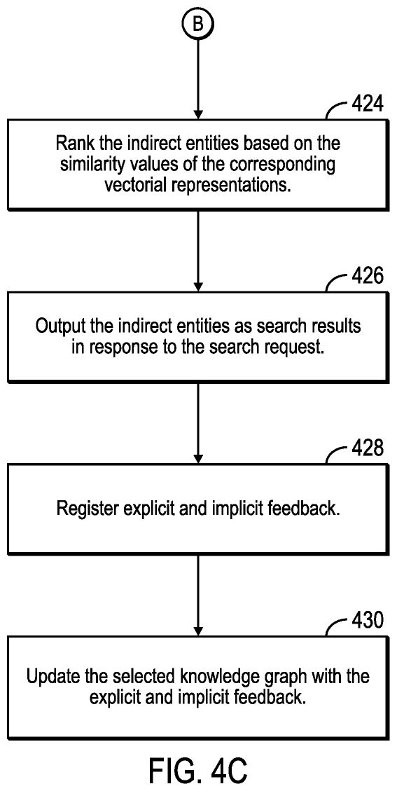

FIGS. 4A, 4B, and 4C illustrate, in a flowchart, operations for performing a search

using the knowledge graph in accordance with certain embodiments. Control begins at block 400 with the search system 210 receiving a search request for indirect entities for project specific input documents 230. In certain embodiments, a project may refer to programming, performing analysis of a project document, creating a document of understanding, creating a request of proposal, etc. In certain embodiments, the project may be identified with the search request.

In block 402, the search system 210 retrieves the project specific input documents 230. For example, the project specific input documents 230 may include project specifications, source code, source code comments, a research project, a document of understanding, a client proposal, etc.

In block 404, the search system 210 identifies entities and impacts in the project specific input documents 230. In certain embodiments, the search system 210 processes the content of the project specific input documents 230 to identify entities and relationships between the entities. In certain embodiments, the search system 210 processes the textual context of the project specific input documents 230 (e.g., using natural language processing) and identifies main entities and the relationships between them. With embodiments, different techniques may be used to process the textual content. For example, the search system 210 may use techniques to identify the subjects of sentences and elect those as the main entities and identify the verbs of those sentences as relationships linking the entities.

In block 406, the search system 210 selects a knowledge graph. In certain embodiments, the search system 210 selects the knowledge graph from a plurality of knowledge graphs. In certain other embodiments, for selecting the knowledge graph, the search system 210 selects a subgraph (or portion) of a single, large knowledge graph. The search system 210 may select the knowledge graph or subgraph based on entities of the project specific input documents 230 matching or being similar to entities of the knowledge graph or subgraph. For example, if the entities of the project specific input documents 230 include: desktop, tablet, and smart phone, then a knowledge graph that includes at least one of those entities is selected.

In block 408, the search system 210 generates a new knowledge graph with the entities and impacts in the selected knowledge graph (created from entities and impacts of the general input documents) and the entities and impacts in the project specific input documents. From block 408 (FIG. 4A), processing continues to block 410 (FIG. 4B).

In certain embodiments, the search system 210 identifies subjects of sentences as entities, identifies verbs as relationships linking the entities, and identifies verbs to determine the impacts, where the subjects and verbs are from the project specific input documents.

In certain embodiments, for the processing of block 408, the search system 210 updates the selected knowledge graph with the identified entities. In certain other embodiments, for the processing of block 408, the search system 210 generates a knowledge graph with the entities in the project specific input documents and combines that with the selected knowledge graph to generate the new knowledge graph. The new knowledge graph includes both the entities of the general input documents 220 and the entities of the project specific input documents 230.

In block 410, the search system 210 generates embedding entities for the entities in the new knowledge graph, where each of the embedding entities has a corresponding vectorial representation comprising multiple numerical values representing a position in an embedding space. That is, the search system 210 creates node representations in an embedding space. In certain embodiments, the search system 210 processes the updated knowledge graph to create vectorial representations for the nodes. For example, this may be done using any technique to convert a graph to a vectorial representation (e.g., a node2vec technique). Entity embedding may be described as a technique that uses an encoder decoder to represent information in a latent space. In entity embedding from a knowledge graph, the entities (represented as nodes with categorical data and/or numerical values) are represented using numeric values (embedding entities). Entities in the embedding space may be said to map to the entities, from the knowledge graph, in a latent space.

In block 412, the search system 210 determines similarity values for each pair of the corresponding vectorial representations. In certain embodiments, the search system 210 applies a similarity measure to identify the similarity values. In certain embodiments, the similarity measure may be a cosine similarity value (i.e., a cosine of the angle between vectorial representations), a Euclidean distance similarity value (i.e., distance between ends of the vectorial representations), a dot product (i.e., the cosine similarity value multiplied by lengths of both vectorial representations), etc.

Cosine similarity may be described as a measure of similarity between two non-zero vectorial representations defined in the embedding space. Cosine similarity is the cosine of the angle between the vectorial representations. For example, two vectorial representations that are the same have a cosine similarity of 1, which indicates that they are the same entity in the knowledge graph and the same vectorial representation in the embedding space. As another example, for two vectorial representations that have a cosine similarity of about 0.5, the vectorial representations represented in the embedding space are pointing to the same direction, representing the entities that have a similar/next representation in the embedding space and in the knowledge graph. In certain embodiments, the search system 210 retrieves pairs of entities and embeddings (entity, embedding).

In block 414, the search system 210 retrieves embedding entities similar to the entities identified in the project specific input documents 230 based on the similarity values of the corresponding vectorial representations exceeding a similarity threshold. In certain embodiments, the search system 210 retrieves embedding entities that have similarity values of corresponding vectorial representations that are above a similarity threshold (e.g., initialized to 0.5 by a system administrator), which represent entities that are most similar to the entities identified in the project specific input documents 230.

In block 416, the search system 210 determines whether any indirect entities are found among the retrieved embedding entities. In certain embodiments, this conditional determines whether any new entity was identified (i.e., any new entity similar to but not explicitly mentioned in the project specific input documents 230). In certain embodiments, the search system 210 uses the pairs of entities and embeddings to determine which entities are present in the project specific input document and which entities are not found in the project specific input document. The entities that are not found in the project specific input document may be impacted by the project. If any indirect entities were found, processing continues to block 420, otherwise, processing continues to block 418.

In block 418, the search system 210 decreases the similarity threshold and processing loops back to block 414. That is, in case no new indirect entity (from the embedding space) is identified, then the similarity threshold is decreased (e.g., decreasing the similarity threshold by 0.05) to retrieve more entities from the embedding space.

In block 420, the search system 210 determines whether the indirect entities found fit into the User Interface (UI). If so, processing continues to block 424 (FIG. 4C), otherwise, processing continues to block 422. In certain embodiments, this conditional determines whether the number of indirect entities is too large to be displayed in the UI or may result in information overload for the user.

In block 422, the search system 210 increases the similarity threshold and processing loops back to block 414. That is, in case number of indirect entities (from the embedding space) is too large for the project at hand or too large for the UI, then the similarity threshold is increased (e.g., by 0.05) to retrieve the most impacted indirect entities.

Thus, with embodiments, the search system 210 automatically adjusts the similarity threshold to retrieve indirectly impacted entities that are not explicitly mentioned in the project specific input documents 230.

In block 424, the search system 210 ranks the indirect entities based on the similarity values of the corresponding vectorial representations. That is, vectorial representations that are more similar in the embedding space will have a higher similarity value, and the vectorial representations may be ranked based on these similarity values.

In block 426, the search system 210 outputs the indirect entities as search results in response to the search request. In certain embodiments, the search system 210 presents a recommendation of indirect entities that may be impacted by the technology in development.

In block 428, the search system 210 registers explicit and implicit feedback. In certain embodiments, the search system 210 registers (e.g., identifies and stores) how users interact with the indirect entities either by identifying explicit feedback (e.g., rating as useful or changing the input document/code source now mentioning the recommended stakeholders, etc.) or by identifying implicit interaction (e.g., reading time, mouse movements, etc.).

In block 430, the search system 210 updates the selected knowledge graph with the explicit and implicit feedback. In certain embodiments, the search system 210 updates edge weights of the selected knowledge graph to represent higher relevance of knowledge graph connections based on how users interact with the indirect entities.

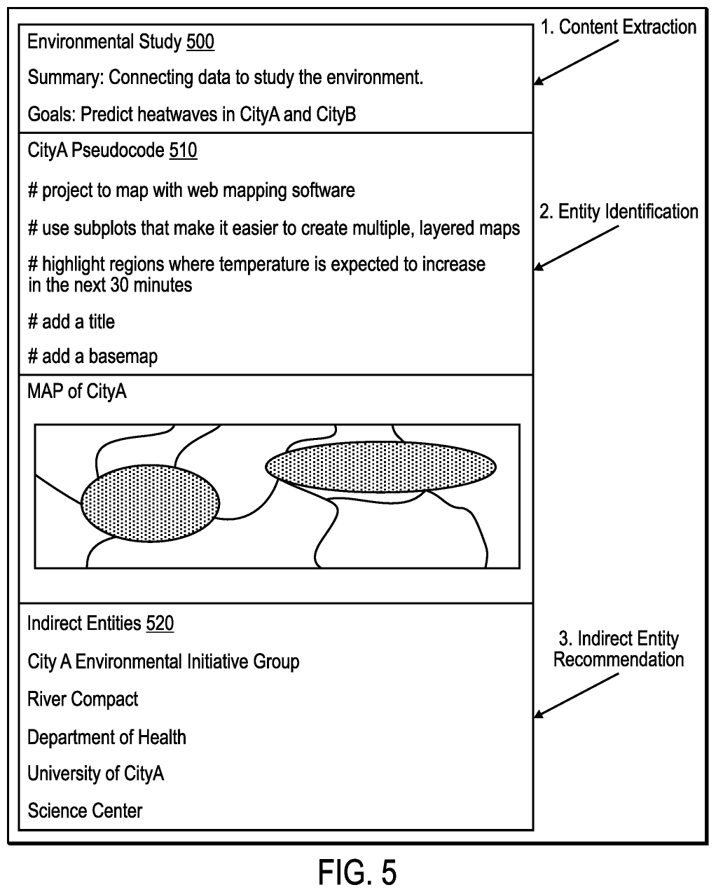

FIG. 5 illustrates an example of generation of indirect entities in accordance with certain embodiments. In FIG. 5, first, the search system 210 extracts content from the environmental study 500. Then, the search system 210 identifies entities in the CityA pseudocode 510. The search system 210 recommends indirect entities 530.

In certain embodiments, the search system 210 provides a plugin to process source code and source code comments as input to identify current stakeholders (a type of entity) and recommend indirectly affected stakeholders during development stages.

In certain embodiments, the search system 210 provides a plugin to represent indirect stakeholders in a stakeholder map, which also represents impacts, power dynamics, reach, and spheres of influence.

In certain embodiments, the search system 210 uses verbal discussions (e.g., meetings) to create a diagram of stakeholders (i.e., a stakeholder mapping).

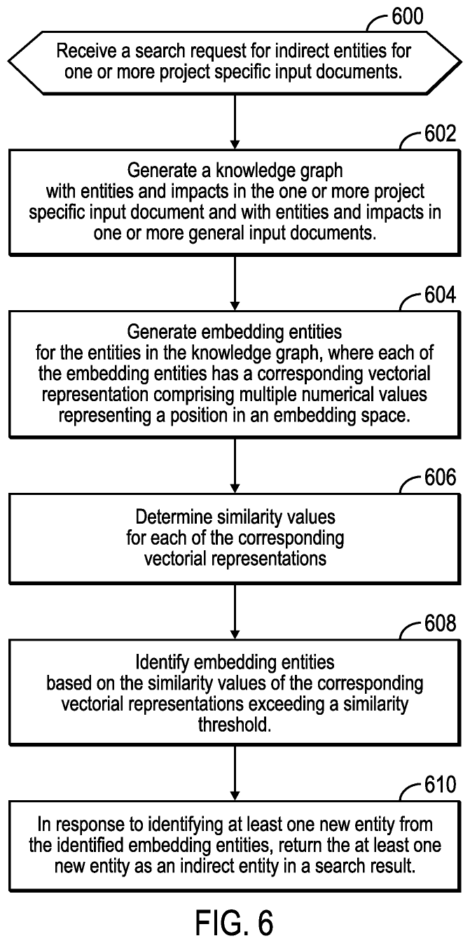

FIG. 6 illustrates, in a flowchart, operations for identifying indirect entities using a knowledge graph in accordance with certain embodiments. Control begins at block 600 with the search system 210 receiving a search request for indirect entities for one or more project specific input documents. In block 602, the search system 210 generates a knowledge graph with entities and impacts in the one or more project specific input document and with entities and impacts in one or more general input documents.

In block 604, the search system 210 generates embedding entities for the entities in the knowledge graph, where each of the embedding entities has a corresponding vectorial representation comprising multiple numerical values representing a position in an embedding space. In block 606, the search system 210 determines similarity values for each of the corresponding vectorial representations.

In block 608, the search system 210 identifies embedding entities based on the similarity values of the corresponding vectorial representations exceeding a similarity threshold. In block 610, in response to identifying at least one new entity from the identified embedding entities, the search system 210 returns the at least one new entity as an indirect entity in a search result. In certain embodiments, the at least one new entity comprises a stakeholder that is indirectly impacted by a project associate with the project specific input documents.

In certain embodiments, the search system 210 identifies indirectly impacted stakeholders based on entity identification and stakeholder connections. The search system 210 processes textual content of input documents and identifies entities and relationships between the entities, where processing the textual content further comprises identifying subjects of sentences and selecting the subject as the identified entities, identifying verbs linking the identified entities, and identifying the verbs associated to impacts. Based on the processed textual content, the search system 210 generates a knowledge graph that combines the identified entities and the impacts for structuring stakeholders. The search system 210 generates vectorial representations of nodes/entities in the knowledge graph by converting the knowledge graph to a vectorial representation. The search system 210 selects embeddings of entities in an embedding space of the knowledge graph that are most similar to the identified entities using a similarity threshold. The search system 210 identifies indirect stakeholders by determining whether any new entity was identified in the selected embeddings, where the determining further comprises identifying new entities similar to and not explicitly mentioned in the input documents. The search system 210 ranks a list of the indirect stakeholders based on similarity in the embedding space and mapping in the knowledge graph. The search system 210 presents a recommendation of the indirect stakeholders impacted by a technology in development.

In certain embodiments, the search system 210, in response to not identifying any new entity, decreases the similarity threshold to retrieve more entities from the embedding space.

In certain embodiments, the search system 210 detects how users interact with impacted entities by identifying implicit interaction including reading time and mouse movements, and by identifying explicit feedback including a rating and changing the input documents.

In certain embodiments, the search system 210 updates the document/code source to mention the recommended stakeholders.

In certain embodiments, the search system 210 generates and updates weights and relevance of the knowledge graph edges based on how users interact with the impacted entities.

With embodiments, the search system 210 falls in the realm of responsible computing as the search system 210 identifies indirect entities to enable proper determination of risks, consequences, and harms and to address those risks, consequences, and harms by planning mitigation strategies. In this sense, the proper identification of indirect entities affected by a certain technology supports teams to develop technologies beyond the well-known user-centered or utility-centered approach.

Thus, the search system 210 considers a project specific input document as natural language describing a product, research, or project and outputs search results of entities (e.g., parties, constituents, organizations, communities, biomes, environment, etc.) that may be impacted by technology described in the project specific input document 230. In this manner, the search system 210 enables a responsible approach that supports mitigation strategies.

With embodiments, businesses that create technology benefit from the identification (e.g., recommendation and prediction) of entities impacted by a technology. This may help the businesses with employing mitigation strategies, creating new lines of business, avoiding loss in cases of damage to the brand, and managing public relations.

With embodiments, the search system 210 takes into account indirect stakeholders in a preventive way. That is, the search system 210, in the realm of responsible and inclusive technologies, provides a proper understanding of impacted stakeholders to properly determine consequences and plan mitigation strategies.

In certain embodiments, the search system 210 identifies indirectly impacted stakeholders based on entity identification and their connections. The search system 210 processes text in natural language to extract entities. The search system 210 structures the extracted entities in a knowledge graph. The search system 210 expands this knowledge graph by processing social networks. The search system 210 identifies indirectly impacted stakeholders as the entities that are a pre-determined number of hops away from a subgraph generated from the entities extracted from text content with the natural language processing.

Projects often start with Document of Understanding or a project draft stating stakeholders directly associated with product design/development/use. With embodiments, the search system 210 identifies stakeholders impacted that were not identified in project phases. In particular, the search system 210 processes the Document of Understanding or a project draft (i.e., any initial project proposal) and recommends further analysis of the project considering indirectly impacted stakeholders.

The terms “an embodiment”, “embodiment”, “embodiments”, “the embodiment”, “the embodiments”, “one or more embodiments”, “some embodiments”, and “one embodiment” mean “one or more (but not all) embodiments of the present invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

In the described embodiment, variables a, b, c, i, n, m, p, r, etc., when used with different elements may denote a same or different instance of that element.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the present invention need not include the device itself.

The foregoing description of various embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, embodiments of the invention reside in the claims herein after appended. The foregoing description provides examples of embodiments of the invention, and variations and substitutions may be made in other embodiments.

What is claimed is:

1. A computer-implemented method, comprising operations for:
receiving a search request for indirect entities for one or more project specific input documents;
generating a knowledge graph with entities and impacts in the one or more project specific input document and with entities and impacts in one or more general input documents;
generating embedding entities for the entities in the knowledge graph, wherein each of the embedding entities has a corresponding vectorial representation that represents a position in an embedding space;
identifying embedding entities based on similarity values of the corresponding vectorial representations exceeding a similarity threshold; and
in response to identifying at least one new entity from the identified embedding entities not explicitly found in the one or more project specific input documents, returning the at least one new entity as an indirect entity in a search result.

2. The computer-implemented method of claim 1, wherein the one or more project specific documents comprise project specifications, source code, and source code comments.

3. The computer-implemented method of claim 1, further comprising operations for:
in response to determining that the identified at least one new entity does not fit into a user interface, increasing the similarity threshold.

4. The computer-implemented method of claim 1, further comprising operations for:
in response to determining that no new entity was identified, decreasing the similarity threshold.

5. The computer-implemented method of claim 1, wherein the at least one new entity comprises a stakeholder that is indirectly impacted by a project associate with the project specific input documents.

6. The computer-implemented method of claim 1, further comprising operations for:
generating another knowledge graph with the entities and the impacts in the one or more general input documents;
receiving explicit and implicit feedback; and
updating weights of the another knowledge graph based on the explicit and the implicit feedback.

7. The computer-implemented method of claim 1, further comprising operations for:
in response to identifying a plurality of new entities from the identified embedding entities not explicitly found in the one or more project specific input documents, ranking the new entities based on the similarity values of the corresponding vectorial representations.

8. A computer program product, the computer program product comprising a computer readable storage medium having program instructions embodied therewith, the program instructions executable by a processor to cause the processor to perform operations for:
receiving a search request for indirect entities for one or more project specific input documents;
generating a knowledge graph with entities and impacts in the one or more project specific input document and with entities and impacts in one or more general input documents;
generating embedding entities for the entities in the knowledge graph, wherein each of the embedding entities has a corresponding vectorial representation that represents a position in an embedding space;
identifying embedding entities based on similarity values of the corresponding vectorial representations exceeding a similarity threshold; and
in response to identifying at least one new entity from the identified embedding entities not explicitly found in the one or more project specific input documents, returning the at least one new entity as an indirect entity in a search result.

9. The computer program product of claim 8, wherein the one or more project specific documents comprise project specifications, source code, and source code comments.

10. The computer program product of claim 8, wherein the program instructions are executable by a processor to cause the processor to perform operations for:
in response to determining that the identified at least one new entity does not fit into a user interface, increasing the similarity threshold.

11. The computer program product of claim 8, wherein the program instructions are executable by a processor to cause the processor to perform operations for:
in response to determining that no new entity was identified, decreasing the similarity threshold.

12. The computer program product of claim 8, wherein the at least one new entity comprises a stakeholder that is indirectly impacted by a project associate with the project specific input documents.

13. The computer program product of claim 8, wherein the program instructions are executable by a processor to cause the processor to perform operations for:
generating another knowledge graph with the entities and the impacts in the one or more general input documents;
receiving explicit and implicit feedback; and
updating weights of the another knowledge graph based on the explicit and the implicit feedback.

14. The computer program product of claim 8, wherein the program instructions are executable by a processor to cause the processor to perform operations for:
in response to identifying a plurality of new entities from the identified embedding entities not explicitly found in the one or more project specific input documents, ranking the new entities based on the similarity values of the corresponding vectorial representations.

15. A computer system, comprising:
one or more processors, one or more computer-readable memories and one or more computer-readable, tangible storage devices; and
program instructions, stored on at least one of the one or more computer-readable, tangible storage devices for execution by at least one of the one or more processors via at least one of the one or more computer-readable memories, to perform operations comprising:
receiving a search request for indirect entities for one or more project specific input documents;
generating a knowledge graph with entities and impacts in the one or more project specific input document and with entities and impacts in one or more general input documents;
generating embedding entities for the entities in the knowledge graph, wherein each of the embedding entities has a corresponding vectorial representation that represents a position in an embedding space;
identifying embedding entities based on similarity values of the corresponding vectorial representations exceeding a similarity threshold; and
in response to identifying at least one new entity from the identified embedding entities not explicitly found in the one or more project specific input documents, returning the at least one new entity as an indirect entity in a search result.

16. The computer system of claim 15, wherein the one or more project specific documents comprise project specifications, source code, and source code comments.

17. The computer system of claim 15, wherein the program instructions further perform operations comprising:
in response to determining that the identified at least one new entity does not fit into a user interface, increasing the similarity threshold.

18. The computer system of claim 15, wherein the program instructions further perform operations comprising:
in response to determining that no new entity was identified, decreasing the similarity threshold.

19. The computer system of claim 15, wherein the at least one new entity comprises a stakeholder that is indirectly impacted by a project associate with the project specific input documents.

20. The computer system of claim 15, wherein the program instructions further perform operations comprising:
generating another knowledge graph with the entities and the impacts in the one or more general input documents;
receiving explicit and implicit feedback; and
updating weights of the another knowledge graph based on the explicit and the implicit feedback.
